(19) United States
(12) Patent Application Publication
(10) Pub. No.: US 2021/0341902 A1
(43) Pub. Date: Nov. 4, 2021

(54) METHOD FOR COMPUTER ASSISTANCE IN THE MANAGEMENT OF A PRODUCTION LINE

(71) Applicant: SIDEL PARTICIPATIONS, OCTEVILLE-SUR-MER (FR)

(72) Inventor: Anthony BARRE, OCTEVILLE-SUR-MER (FR)

(21) Appl. No.: 17/273,051

(22) PCT Filed: Sep. 6, 2019
(86) PCT No.: PCT/FR2019/000142

§ 371 Date: Mar. 3, 2021

(30) Foreign Application Priority Data
Sep. 6, 2018 (FR) 1857980

(51) Int. Cl. G05B 19/409; G05B 19/4063

(52) U.S. Cl. CPC G05B 19/409; G05B 19/4063; G05B 2219/32014; G05B 2219/24012; G05B 2219/23148

(57) ABSTRACT

The present invention relates to a method for computer assistance in the management of a production line. In the method a portable terminal executes and displays a human-machine interface (HMI), and the terminal visualizes through display means at least one module of said production line. The method performs a geographical localization of said terminal within a three-dimensional reference frame centered on said production line and determining the position of said terminal with respect to said module. The method also displays via said display means in superimposition a virtual model limited to said module as a function of said determined position of said terminal.

The field of the present invention is that of the management of a production line.

The invention relates more particularly to the computer assistance of an operator in the management of a module of a production line.

In a known manner, a production line is managed from a centralized supervision station located at a fixed site on said line. For obvious optimization reasons, certain commands from such a station have been moved to a mobile terminal, which can be carried or worn by an operator. Said portable terminal serves as execution medium for a software human-machine interface (HMI) dedicated to said production line. Consequently, the operator can supervise a module of the line while being nearby and in direct view.

Recently, to improve the involvement of the operator, the HMI displays a virtual model of certain elements of said line by way of a display means with which said portable terminal is equipped. Generally, said display means consist of a screen on which said virtual model is displayed superposed on an image or on a video stream recorded in real time by a camera with which said portable terminal is equipped.

Recently, several digital holographic technologies have made it possible for a virtual model to be displayed on a translucent surface, superposed on the vision of the user, for example in the form of a holographic pair of glasses or headset. The means for displaying the virtual model then consist of this holographic translucent surface. Documents WO 2007/066166 and WO 2017/186450 describe mobile terminals, in the form of a headset or pair of glasses worn by the operator, which display a mixed reality superposed on their view of the production line.

The HMI therefore offers the operator an augmented reality which can visually highlight one or more elements of the production line which the operator has to monitor. It is then necessary to align the virtual model according to the orientation of the portable terminal, or to center said virtual model on an element of the module chosen by the operator, in order that the real and virtual images are perfectly superposed.

In particular, in order to select an element of the production line to be monitored, a system for detecting and reading a unique identification code applied to said element, directly by printing a marking or by applying a tag, has been devised. Document EP 2 860 597 targets the optical detection and the identification of a two-dimensional code, of matrix type, by a mobile terminal equipped with optical reading means. After identification, a virtual model of the identified element can be displayed superposed and aligned on the captured image, notably with a transparency and/or colors visually highlighting it.

Already, a disadvantage of this optical recognition lies in the positioning of the codes, which must necessarily be visually accessible in a direct line for each element which might be monitored. Moreover, the optical reading can cause reflections, notably because of the shiny appearance of certain components, preventing or making the identification of the code difficult.

Another disadvantage is related to the depth of field between the identified element and the display of its virtual model, leading to misalignments between the superposition of the real elements and the virtual model.

What is more, it is essential that the recognition be performed in a direct line with respect to the surroundings. In the case of there being an obstacle between the operator and the real element, it is then not possible to easily superpose the virtual model, with misalignments being generated once more.

Once an element has been identified, the HMI provides the operator with interactivity, allowing information relating to said element to be collected, notably by way of a centralized computer system, and to be displayed. It is then also possible to transmit virtual instructions, notably relating to steps for the maintenance of such an element. These additions consist of a virtual reality which, combined with the augmented reality, form a mixed reality, lending computer assistance to the operator in their supervision and their tasks to accomplish.

In addition, while, theoretically, such a virtual representation of all of the elements of a production line is conceivable, it is difficult to achieve with current devices. This is because a major constraint on displaying a mixed reality, notably by way of a portable terminal, lies in the significant amount of data to be processed and to be displayed on said terminal with regard to its limited computer resources due to its portable nature, in particular its graphical resources. There is a resulting limitation on the amount of data which can be displayed, or else a detrimental delay before the display by the HMI. Furthermore, the execution of the three-dimensional virtual model is extremely resource-intensive, needing significant dedicated graphical resources for the computer processing thereof. Currently, mobile terminals allow the processing and display of the whole virtual model of a production line only with difficulty. What is more, the addition of the optical reading of an identification code leads to an additional information-processing load for the portable terminal.

The aim of the invention is to overcome the disadvantages of the prior art by proposing the targeting of the virtual model executed on the terminal carried or worn by an operator by way of precise locating of the site and of the orientation of said terminal with respect to the production line. In other words, the invention limits the virtual model to be displayed with respect to the exact position of the terminal, without loading and/or transferring all of the data associated with the production line. Thus, the amount of data, notably graphical data, processed and displayed is reduced, ensuring smooth and instantaneous execution by said portable terminal.

To do this, the invention provides for precisely determining the position of the portable terminal with respect to the production line, then for displaying only the virtual model corresponding to the determined position.

To this end, the invention relates to a method for computer assistance in the management of a production line, in which, furthermore:
a portable terminal executes and displays a human-machine interface (HMI);
said terminal shows, by way of display means, at least one module of said production line;

wherein such a method comprises at least the following steps:
geographically locating said terminal within a three-dimensional frame of reference centered on said production line and determining the position of said terminal with respect to said module;
displaying, via said display means and in superposition, a virtual model limited to said module according to said determined position of said terminal.

According to other, non-limiting, additional features, the position of said terminal can be determined by means of at least one three-dimensional position sensor connected to said terminal.

The orientation of said terminal can be determined by way of at least a first and a second three-dimensional position sensor which are spaced apart from each other and are connected to said terminal.

Said display means can comprise a screen and a video stream of said module is captured and is displayed by way of said screen.

Said display means can comprise a translucent surface and said limited virtual model is holographically displayed on said translucent surface.

Said frame of reference can be centered by positioning at least two transmitting/receiving bases which are spaced apart from each other and are located on said production line.

Thus, the geographic locating ensures extremely precise positioning, allowing the virtual model to be delimited to the exact site and according to the precise orientation of the portable terminal, according to where the operator is located with respect to the production line.

Moreover, the precision of the positioning according to the invention ensures perfect alignment between the virtual model and the real capture, dispensing with the detection and with the identification of an element of the module.

Furthermore, the invention allows the virtual model corresponding to the targeted module to be displayed and aligned perfectly, no matter what the real field of vision of the operator or the field of capture of the camera are, overcoming any obstacle there may be between the terminal and/or the operator and the machine. Consequently, by way of the exact positioning obtained by the invention, the display of the model on the terminal is more precise and independent of possible changes in the surroundings.

Other features and advantages of the invention will become apparent from the following detailed description of the non-limiting embodiments of the invention, with reference to the attached figures, in which:

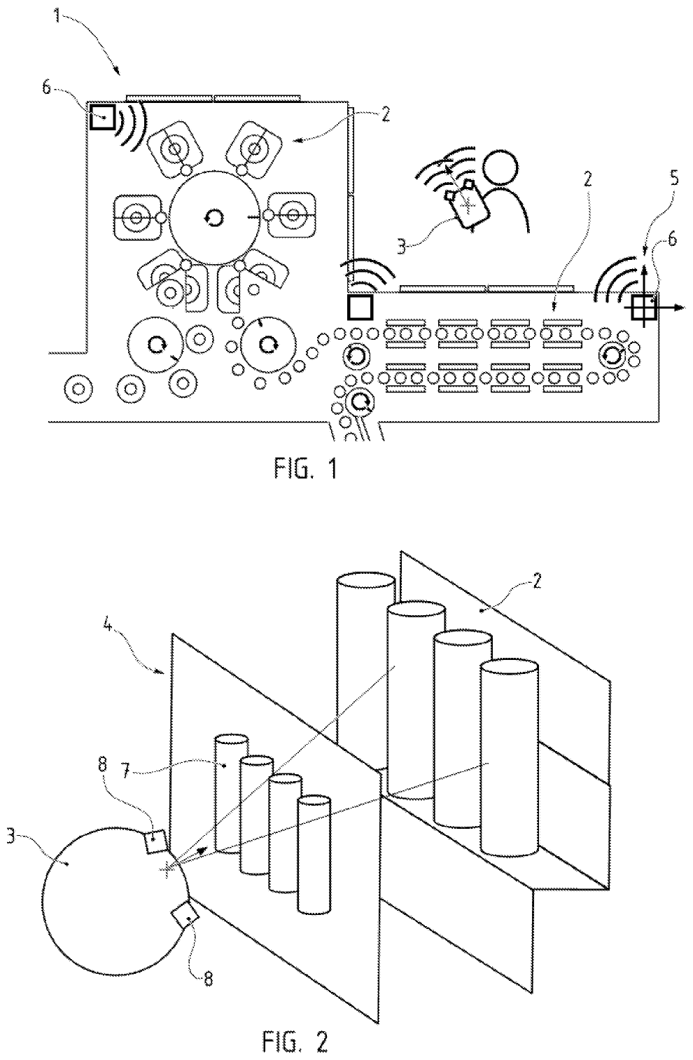

FIG. 1 schematically represents a view from above of a production line with a plurality of modules, showing a preferred, non-limiting, embodiment with a plurality of bases determining a frame of reference centered on said production line, and an operator with a portable terminal, provided with two sensors, the position and the orientation of which are determined within said frame of reference;

FIG. 2 schematically represents a view in perspective of an example representation of a virtual model displayed on display means of holographic type, superposed on the real module, showing the field of vision of the operator.

The present invention relates to the management of a production line 1.

Said production line 1 comprises at least one module 2, preferably a plurality of modules 2. Each module 2 processes the products which pass through it.

According to the example embodiment represented in FIG. 1, showing a part of a production line 1, a manufacturing station for manufacturing containers, such as bottles made from plastic, comprises, from upstream to downstream, a preform-supplying module followed by a heating module supplying a blow molding or stretch blow molding module which turns out bottles through a conveyor module.

Further, the invention relates to computer assistance in the management of said production line 1, more precisely computerized assistance aiding an operator in the management of one or more of the modules 2 of said production line 1.

To do this, the production line 1 is equipped with dedicated computer tools which are configured for the purpose of managing it. In particular, a terminal 3 executes and displays a human-machine interface (HMI) 4. Said terminal 3 is provided with means for displaying at least one module 2. The display means also allow said HMI 4 to be shown.

Such a terminal 3 is designed to be portable. The terminal 3 can be in the form of a computer terminal, in the form of a tablet or of a cell phone or of a connected watch, that is to say a terminal 3 equipped with a screen. Said terminal 3 can also comprise a holographic display surface, such as a holographic pair of glasses or headset.

Thus, the operator can carry or wear said terminal 3 over the course of their movements along the production line 1, having direct access to all or part of the computerized management of a module 2 by way of said HMI 4.

Further, by way of said HMI 4, non-limitingly, the operator can select various operating modes of a module 2, check the state of certain components or follow the production in progress, check potential anomalies, adjust settings, enter data relating to the production and monitor and perform a maintenance step.

In this context, the invention provides for automatically selecting the module 2 with respect to the position of the operator, that is to say to the position of the terminal which they are carrying or wearing.

To do this, provision is made for geographically locating said terminal 3 within a three-dimensional frame of reference 5 centered on said production line 1. By centering the frame of reference 5, the relative position of the operator with respect to the production line 1 is then known exactly.

This centering can be performed via bases 6. In particular, at least one base 6 is positioned in a fixed and determined place, at a site attached to one of the machines in the production line 1 and/or its surroundings, for example the structure of the building. Other bases 6 can be positioned in various places, preferably fixed, but potentially in a mobile manner, as long as the relative distance between each base, above all from the base 6 for centering the frame of reference 5, is known exactly at each instant.

According to one embodiment, said frame of reference 5 is centered by positioning at least two transmitting/receiving bases on said production line 1.

The frame of reference is therefore geo-centered on a transmitter/receiver, preferably a plurality thereof, allowing triangulation of the terminal 3.

To this end, the terminal 3 can incorporate means suitable for allowing the remote exchange of information by wireless communication means.

Preferably, the transmission/reception is of electromagnetic type, in the form of electromagnetic waves, notably of RFID (for “radio-frequency identification”) type, for example broadband or short-range.

In particular, at least one three-dimensional position sensor 8 is connected to said terminal 3. It is then possible to determine the position of said terminal 3 with respect to said module 2.

Further, at least a second three-dimensional position sensor 8 is connected to said terminal 3. Thus, it is possible to determine the orientation of said terminal 3 with respect to the production line 1, but above all with respect to a module 2 positioned nearby. In other words, it is possible to know how the terminal 3 is positioned with respect to the module 2—opposite, turned toward the module 2 or in another direction.

In the context of RFID technology, a sensor 8 can be in the form of an RFID tag, which transmits a signal on reception of the signal sent by the one or more bases 6.

Consequently, each sensor 8 has to be connected to the terminal 3 in a fixed or attached manner, without relative modification of the position of one with respect to the other.

Furthermore, this contactless, wireless determination of the position and of the orientation of the terminal 3 allows any obstacle there may be between said terminal 3 and the production line 1, in particular a module 2, to be overcome.

Further, the invention provides for displaying, via said display means and in superposition, a virtual model 7 limited to said module 2 according to said determined position of said terminal 3. In short, once the position of the terminal 3 has been identified, above all its orientation, it is possible to limit the possible interactions of the user with the modules 2 positioned nearby. This choice allows a part of the virtual model 3 to be displayed on the terminal 3 to be targeted, instead of loading and executing the one or more virtual models of the whole of the production line 1. Thus, the possible transfer and storage of data, but above all the execution on the terminal 3 is thereby eased, allowing the implementation, the computer components and also the format of said terminal 3 to be simplified.

The virtual model 7 comprises at least one image of at least one component of the module 2. For example, this image can be either in two dimensions or in three dimensions. The image consists of a digital assembly which can be produced either by digitizing said component with the aid of a scanner or by being created with a CAD program, for example SolidWorks.

The term “image” refers to the representation of the shape of an object and is distinct in particular from information relating to that object. The term “image” should not be identified with a parameter giving information on the operating state of the production line such as the machine rate (number of bottles per mold and per hour), the number of bottles filled by the filling machine per hour, etc.

Furthermore, the virtual model 7 can comprise digital, preferably graphical, elements, such as three-dimensional animations or videos. It can form a virtual and/or augmented reality, preferably a mixed reality, assisting the operator in their supervision of the module 2 and in the tasks which they have to accomplish. The virtual model 7 can incorporate interactive virtual elements triggered by the operator, for example a tutorial or an educational program.

Further, the terminal 3 allows the operator to view the surroundings.

To do this, according to a first embodiment, said display means can comprise a screen and a video stream is then captured of said module 2, that is to say the module 2 toward which the terminal 3 is orientated, preferably by video capture means 8 with which it is equipped. Consequently, it is possible to display the captured video stream by way of said screen. It is then possible to superpose thereon the previously defined part of the virtual model 7.

According to another embodiment, said display means can comprise a translucent surface and the operator can see directly therethrough. By way of the location and above all by way of the orientation of the terminal 3, it is possible to holographically display said limited virtual model 7 on said translucent surface. In this context, the terminal 3 can be in the form of a holographic pair of glasses or headset.

Thus, the determination of the position and of the orientation of the terminal 3 allows the virtual model 7 to be precisely adjusted to the immediate surroundings of the operator. The result of such a superposition is schematically shown in FIG. 2. The operator can then obtain additional information, such as a course to follow for a maintenance operation, by way of said displayed virtual model 7 which is dedicated to the module 2 in which said operator wishes to intervene.

The use of the invention allows access to the information to be simplified for the operator, without having to select specific data in relation to the module 2 in which they wish to intervene. The invention automatically determines the module 2 with respect to the position of the operator and of the terminal 3 which they are carrying or wearing.

1. A method for computer assistance in the management of a production line (1), in which, furthermore:
a portable terminal (3) executes and displays a human-machine interface (HMI) (4);
said terminal (3) shows, by way of display means, at least one module (2) of said production line (1);
wherein it comprises at least the following steps:
geographically locating said terminal (3) within a three-dimensional frame of reference (5) centered on said production line (1) and determining the position of said terminal (3) with respect to said module (2);
displaying, via said display means and in superposition, a virtual model (7) limited to said module (2) according to said determined position of said terminal (3).

2. The assistance method as claimed in claim 1, wherein the position of said terminal (3) is determined by means of at least one three-dimensional position sensor (8) connected to said terminal (3).

3. The assistance method as claimed in claim 2, wherein the orientation of said terminal (3) is determined by way of at least a first and a second three-dimensional position sensor (8) which are spaced apart from each other and are connected to said terminal (3).

4. The assistance method as claimed in claim 1, wherein said display means comprise a screen and a video stream of said module (2) is captured and is displayed by way of said screen.

5. The assistance method as claimed in claim 1, wherein said display means comprise a translucent surface and said limited virtual model (7) is holographically displayed on said translucent surface.

6. The assistance method as claimed in claim 1, wherein said frame of reference (5) is centered by positioning at least two transmitting/receiving bases (6) so as to be spaced apart from each other and located on said production line (1).

7. The assistance method as claimed in claim 2, wherein said display means comprise a screen and a video stream of said module (2) is captured and is displayed by way of said screen.

8. The assistance method as claimed in claim 3, wherein said display means comprise a screen and a video stream of said module (2) is captured and is displayed by way of said screen.

9. The assistance method as claimed in claim 2, wherein said display means comprise a translucent surface and said limited virtual model (7) is holographically displayed on said translucent surface.

10. The assistance method as claimed in claim 3, wherein said display means comprise a translucent surface and said limited virtual model (7) is holographically displayed on said translucent surface.

11. The assistance method as claimed in claim 2, wherein said frame of reference (5) is centered by positioning at least two transmitting/receiving bases (6) so as to be spaced apart from each other and located on said production line (1).

12. The assistance method as claimed in claim 3, wherein said frame of reference (5) is centered by positioning at least two transmitting/receiving bases (6) so as to be spaced apart from each other and located on said production line (1).

13. The assistance method as claimed in claim 4, wherein said frame of reference (5) is centered by positioning at least two transmitting/receiving bases (6) so as to be spaced apart from each other and located on said production line (1).

14. The assistance method as claimed in claim 5, wherein said frame of reference (5) is centered by positioning at least two transmitting/receiving bases (6) so as to be spaced apart from each other and located on said production line (1).
